(19) United States
(12) Patent Application Publication
(10) Pub. No.: US 2016/0133085 A1
(43) Pub. Date: May 12, 2016

(54) Apparatus, System, and Method for Retrofitting a Parking Meter for Wireless Payment Via Portable Smart Devices, and Wireless Payment Systems and Methods

(71) Applicants: Grant Austin Eagon, Charleston, SC (US); Robert Watkins Sires Wofford, Charleston, SC (US)

(72) Inventors: Grant Austin Eagon, Charleston, SC (US); Robert Watkins Sires Wofford, Charleston, SC (US)

(21) Appl. No.: 14/847,990

(22) Filed: Sep. 8, 2015

Related U.S. Application Data
(60) Provisional application No. 62/046,349, filed on Sep. 5, 2014.

(51) Int. Cl. G07F 17/24; G08B 5/36; H04Q 9/00; G06Q 20/12; G06Q 20/04

(52) U.S. Cl. CPC G07F 17/24; G06Q 20/127; G06Q 20/045; H04Q 9/00; G08B 5/36; H04Q 2209/886; H04Q 2209/40

(57) ABSTRACT

A parking meter accessory for retrofitting a parking meter for wireless communication comprises at least one support for attachment to an external surface of at least a portion of the parking meter and at least one processing device configured for wireless communication, where the at least one support is configured to support the at least one processing device. A retrofitted wireless parking meter including the accessory, a processing center for the wireless payment of parking tickets, a processing center to process remote payment for parking in a parking space, initiated by the smart device, a portable smart device for wireless payment for parking, and a method of retrofitting a conventional parking meter are also disclosed.

### RELATED APPLICATION

The present application claims the benefit of U.S. Provisional Patent Application No. 62/046,349, which was filed on Sep. 5, 2014, is assigned to the assignee of the present application, and is incorporated by reference herein.

### FIELD OF INVENTION

Wireless payment and monitoring of parking meters or parking garage spaces and more particularly, retrofitting conventional parking meters for electronic payment via portable smart devices.

### BACKGROUND OF THE INVENTION

Payment of parking meters and of parking garages is a major inconvenience for both the users of the meters and the municipality that services the meters. Users often have difficulty paying for the appropriate time on the meter or parking spot that they are occupying. Similarly, once an infraction has occurred, paying a fine presents its own set of difficulties.

In some municipalities, car tires are marked with chalk to help identify if a car has overstayed the parking time limit. However, chalk can easily wear off, and it is difficult to prove how long a certain car has occupied the space. Some municipalities use a parking control unit to monitor the use of public parking spaces. However, such systems do not operate at high efficiency. Other municipalities provide their meter maids with T2 system readers to record the checked meters. If the city is not Wi-Fi equipped however, all of the recorded data may be lost from one shift to the next.

Some “smart” parking meters allow payment via credit card, or via pre-paid cards that can be purchased at several locations. However, these systems are inefficient in tracking the actual use of the particular spot by a single user, and are also overly complicated to manage and service.

Some municipalities have implemented programs and systems that provide for remote access or wireless access to pay for parking in a particular location. Scheidt & Boshman and Cale Systems, Inc., Quebec, Canada provide WiFi enabled meters that use citywide wireless Internet to communicate with a central system. Pango, in Israel, allows users to register their vehicle with the company to pay for parking without a meter.

In addition, because of the high frequency of tickets given in the city, due to expired meters, many simply go unpaid until drastic measures (such as the use of a boot) are taken.

### SUMMARY OF THE INVENTION

None of the known parking systems provide for the retrofitting of existing city infrastructure, including existing conventional parking meters, to enable a municipality to operate with the added benefit of wireless payment, without the cost required to replace existing parking meters. Furthermore, none of the known systems allow the user to pay tickets/citations that accrue due to exceeding paid for parking time or not paying for parking.

Embodiments of the invention provide a retrofit to conventional parking meters. Other embodiments of the invention allow users to access a mobile payment system.

By allowing visitors or users to pay for meter usage in accordance with an embodiment of the invention, and/or pay for tickets or other fines that may accrue, the loss of this revenue (unpaid meter time and unpaid fines), as well as the cost needed to implement strict measures, such as the boot, can be avoided. There are significant increases in efficiency for both the city and its employees in terms of time and revenue, as well as for users of the system who can better manage their time to avoid fines, or to remotely pay such fines should they be incurred.

In accordance with an embodiment of the invention, a parking meter accessory for retrofitting a parking meter for wireless communication is disclosed. The parking meter comprises a parking meter head and a pole supporting parking meter head. The parking meter accessory comprises at least one support for attachment to an external surface of at least a portion of the parking meter and at least one processing device configured for wireless communication, where the at least one support is configured to support the at least one processing device. The processing device may be “configured” for wireless communication by including wireless enabling components or being electrically connected or coupled to wireless enabling components, such as Bluetooth and/or WiFi chips or chipsets, for example.

In accordance with another embodiment of the invention, a retrofitted, wireless parking meter is disclosed comprising a non-wireless parking meter and a parking meter accessory as described above.

In accordance with another embodiment of the invention, a processing system is disclosed for wireless payment of parking tickets. The processing system comprises storage storing payment information for a respective user, and a processing device configured to receive an image of a parking ticket, from a user, via a network. The processing device is further configured to read the image to derive a ticket number and cost of the ticket, and to pay the cost of the ticket based on the stored payment information. A method of paying a parking ticket is also disclosed.

In accordance with another embodiment of the invention, a processing system is disclosed comprising storage and a processing device configured to wirelessly communicate with a smart device and/or a retrofitted parking meter to via a network, to process remote payment for parking in a parking space, initiated by the smart device.

In accordance with another embodiment of the invention, a portable smart device is disclosed comprising storage storing a software application, and a processing device configured to communicate wirelessly with a processing center and a conventional parking meter retrofitted to enable wireless communication. The smart device may be configured to communicate with the retrofitted parking meter via Bluetooth and to communicate with a processing center via WiFi, for example.

In accordance with another embodiment of the invention, a method of retrofitting a conventional parking meter without wireless capability is disclosed comprising providing a support supporting a wireless enabled processing device, and attaching the support to an exterior surface of the parking meter.

### BRIEF DESCRIPTION OF THE DRAWINGS

FIG. 1 is a front view of an example of a conventional parking meter;

FIG. 2 is an example of a retrofitted parking meter retrofitted by attaching a parking meter shell, in accordance with an embodiment of the invention;

FIG. 3 is a front view of a front portion of the parking meter shell in accordance with the embodiment of FIG. 2;

FIG. 4A is a schematic representation of a light button of the parking meter shell of FIG. 2, in accordance with an embodiment of the invention;

FIG. 4B is a perspective view of an example of the light button of FIG. 4A;

FIG. 5 is an example of a rear view of the parking meter shell in accordance with the embodiment of FIG. 2;

FIG. 6 is an example of a rear view of the front portion of the parking meter shell of FIG. 3, in accordance with an embodiment of the invention;

FIG. 7 is an example of a rear view of the rear portion of the parking meter shell of FIG. 5, in accordance with an embodiment of the invention;

FIG. 8 is an exploded side view of the retrofitted parking meter, in accordance with the embodiment of FIG. 2;

FIG. 9 is a side view of the example of the assembled, retrofitted parking meter shell of FIGS. 2 and 8;

FIG. 10 is a perspective, breakaway view of another retrofitted parking meter, in accordance with an embodiment of the invention;

FIG. 11 is a block diagram of an example of a system in which the retrofitted parking meter may be used, in accordance with an embodiment of the invention;

FIGS. 12A-12D are flowcharts of an example of a method of operation of the system of FIG. 11, to pay for parking;

FIG. 13 is a flowchart of an example of a method of operation of the system of FIG. 11, to pay for parking tickets; and

FIG. 14 is a flowchart of an example of a method of crediting a user for paid for parking time, when the user leaves the parking spot before the paid for time expired.

### DETAILED DESCRIPTION OF THE DRAWINGS

The embodiments of the invention and the various features and advantages thereto are more fully explained with reference to the non-limiting embodiments and examples that are described and set forth in the following descriptions of those examples. Descriptions of well-known components and techniques may be omitted to avoid obscuring the invention. The examples used herein are intended merely to facilitate an understanding of ways in which the invention may be practiced and to further enable those skilled in the art to practice embodiments of the invention. Accordingly, the examples and embodiments set forth herein should not be construed as limiting the scope of the invention, which is defined by the claims. As used herein, terms such as “a,” “an,” and “the” include singular and plural referents unless the context clearly demands otherwise.

In accordance with embodiments of the invention, a retrofit for conventional (“dumb”) parking meters is provided to enable parking meters to communicate wirelessly with portable user devices, such as smartphones, smart watches, tablets, or Blackberry devices, for example, in order to make wireless payments for parking time at a parking space associated with the meter, through a processing center. Wireless communications may include WiFi, cellular or Bluetooth, communication for example. In accordance with another embodiment of the invention, parking tickets may be paid through a processing center, via a user's smart device.

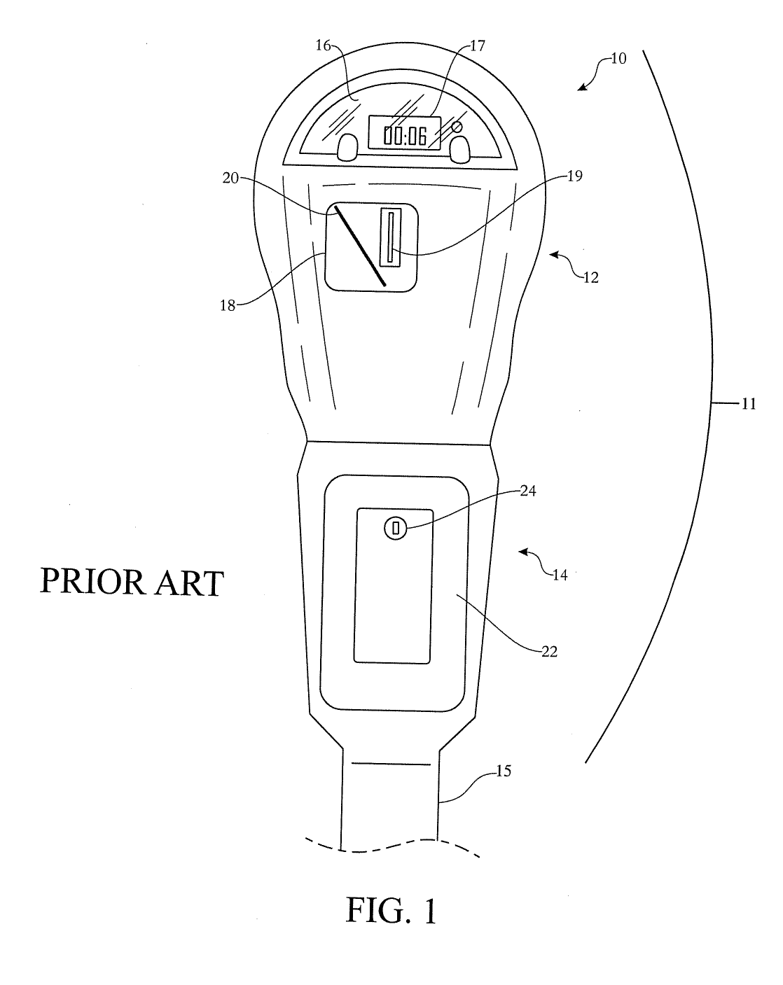

FIG. 1 is an example of a conventional (“dumb”) parking meter 10, which does not have wireless communication capability. In this example, the parking meter 10 includes a head portion 11 including an upper housing 12 and a lower housing 14, and a pole 15 to support the head portion 11, as is known in the art. The lower housing 14 may be mounted to the pole 15, for example.

The upper housing 12 defines a semi-circular transparent window 16 of glass or plastic through which a meter mechanism 17 may be viewed. The meter mechanism 17 typically displays whether paid time on the meter has expired or how much paid time remains. The meter mechanism 17 may display the paid time status mechanically, through an arrow, and/or electronically, through LEDs, for example.

In this example, the upper housing 12 defines a payment section 18 including a coin insertion slot 19 and a credit/debit card slot 20. Some parking meters may provide only the coin insertion slot 19 or only the credit/debit card payment slot 20. Payment sections 18 may have other configurations.

The lower housing 14 contains a store 22 to collect inserted coins. A key hole 24 may be provided for use by a meter maid to collect payments, for example. The upper and lower housings 12, 14 may comprise one or more housing portions connected together.

The rear view of the parking meter 10 may be similar to the front view of FIG. 1, without the payment section 18, and the key slot 24, and delineated store 22. The electrical and mechanical interior components of conventional (dumb) parking meters that provide their functionality are well known in the art.

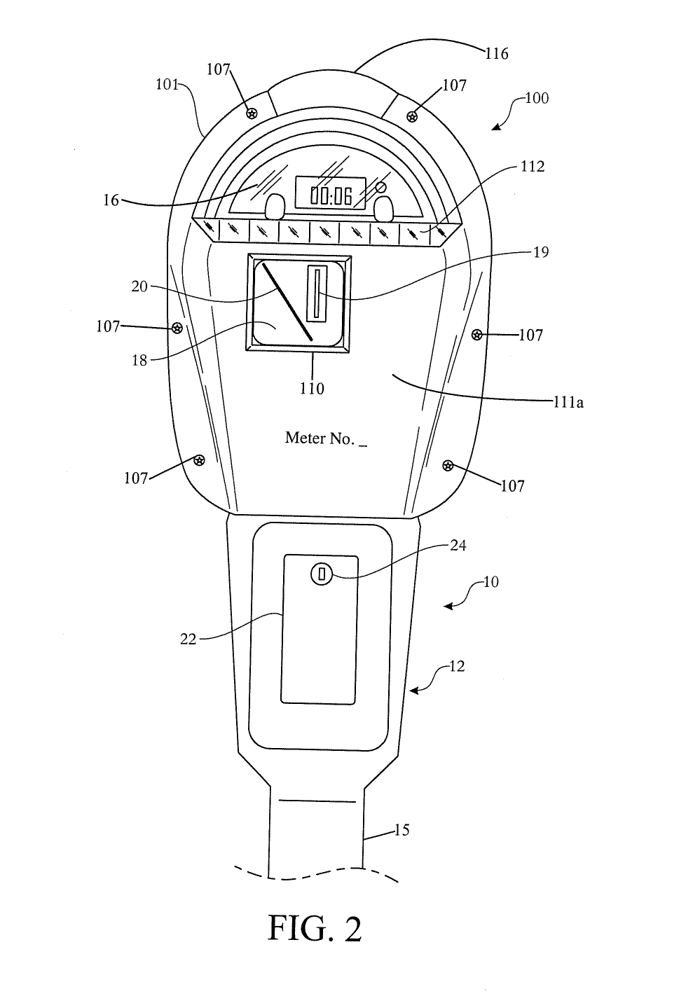

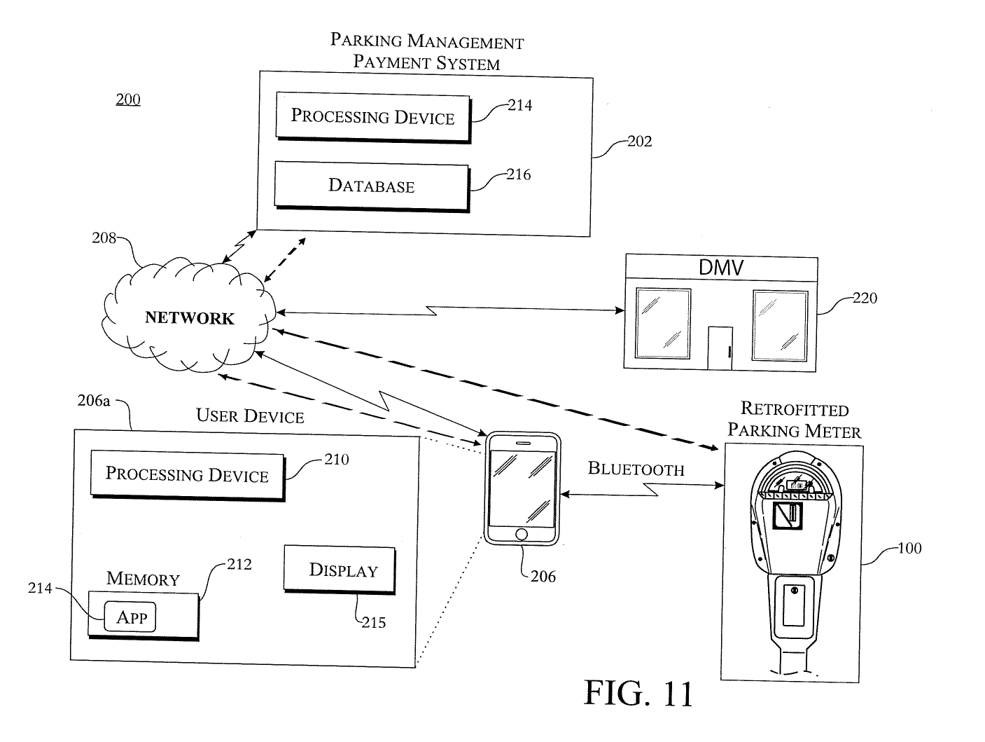

FIG. 2 is a front view of an example of a retrofitted parking meter 100 comprising the conventional (dumb) parking meter 10, such as the parking meter 10 shown in FIG. 1, with a parking meter accessory 101 attached to a portion of the external surface of the parking meter 10 to enable wireless communication. In accordance with embodiments of the invention, it is not necessary to open the parking meter for retrofit. In the example of FIG. 2, the parking meter accessory 101 comprises a shell or “hat” connected to the upper housing 12 of the conventional parking meter 10. The meter shell 101 may be attached to other parts of the parking meter 10, such as to the pole 26, is shown in FIG. 11.

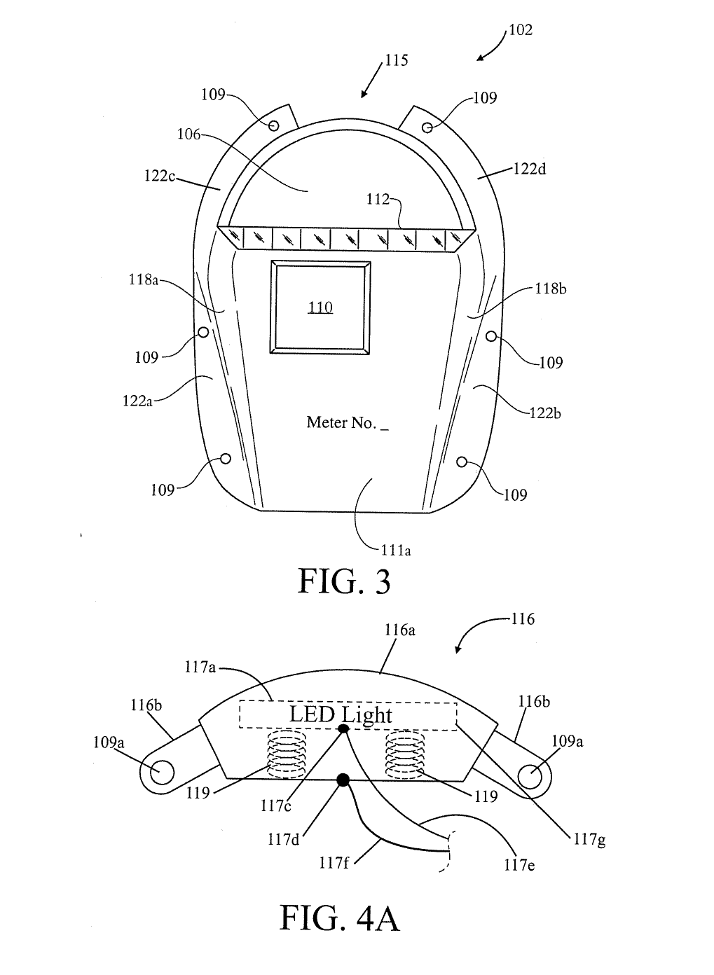

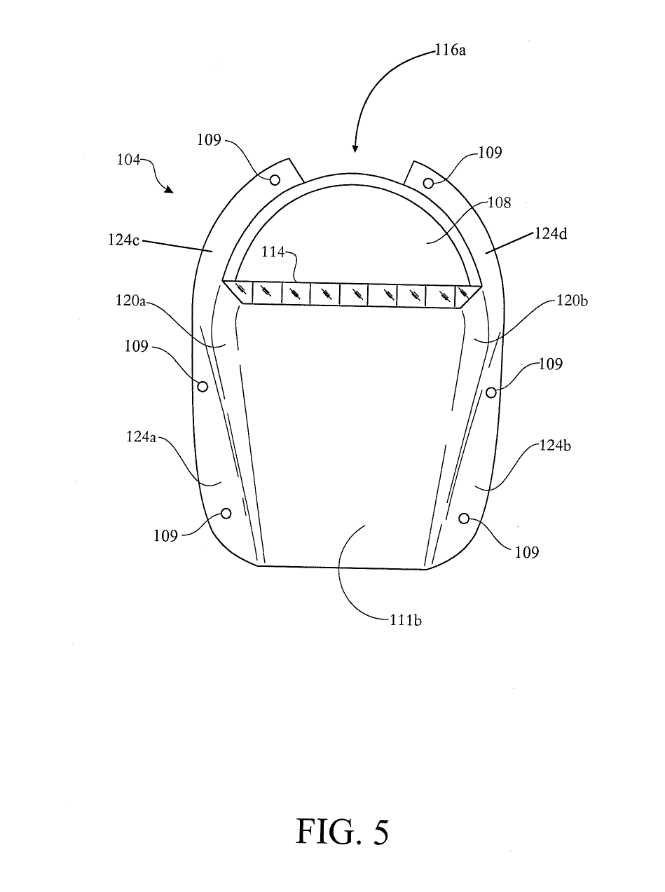

In this example, the parking meter shell 101 comprises a front portion 102, shown in FIGS. 2 and 3, and a rear portion 104, shown in FIG. 5. Connection to the parking meter 10 may be through connection of the front and rear portions 102, 104 to each other, around the meter, so that at least portions of the front and rear portions bear tightly against at least portions of the meter. The front and rear portions 102, 104 are thereby clamped to the meter. Other connection mechanisms may be used.

The external shape of the meter shell 101 may be similar to or the same as the external shape of the parking meter 10 to be retrofitted, but that is not required. A meter number is provided on the front face 111a of the front portion, for example. The meter number may be provided in other and multiple locations.

The front portion 102 and the rear portion 104 of the meter shell 100 in this example are separate housing portions configured to be attached to each other and around the upper housing 12 of the parking meter, to bear against at least a portion of the parking meter 10, as shown in FIGS. 2, 8, and 9. The front portion 102 and the rear portion 104 have internal shapes substantially conforming to the shape of the upper housing 12, but that is not required. While in this example, the meter shell 101 comprises two housing portions 102, 104, it may comprise one or more housings or other structures, such as one or more belts, for example, which can be retrofit to the parking meter 10 and provide at least some of the functionality described herein.

In FIG. 2, screws 107 are shown connecting the front and rear portion 102, 104. Six screws are shown in this example. More or fewer screws or bolts 107 may be provided. The screws or bolts 107 are received within holes 109, shown in FIGS. 3 and 5. Other attachment mechanisms may be used, as discussed below.

In this example, the front portion 102 defines a first, semi-circular opening 106 that corresponds in position with the semi-circular transparent window 16 of the parking meter 10 when retrofitted to the meter, as shown in FIGS. 2 and 3. The rear portion 104 in this example defines a second semi-circular opening 108 that corresponds in position with the rear semi-circular transparent window 16 of the parking meter 10 when retrofitted to the meter, as shown in FIG. 5.

The front portion 102 in this example also defines a square opening 110 in a front surface 111a that corresponds in position to the payment section 18 of the parking meter 10, when the front portion is retrofit to the meter, as shown in FIGS. 2 and 3. The parking meter 10 can thereby continue to operate in a conventional manner to receive payment by coin and/or credit/debit card, if a user does not have a smart device capable of communicating with the meter shell 10, cannot use it at the time, or does not desire to use it.

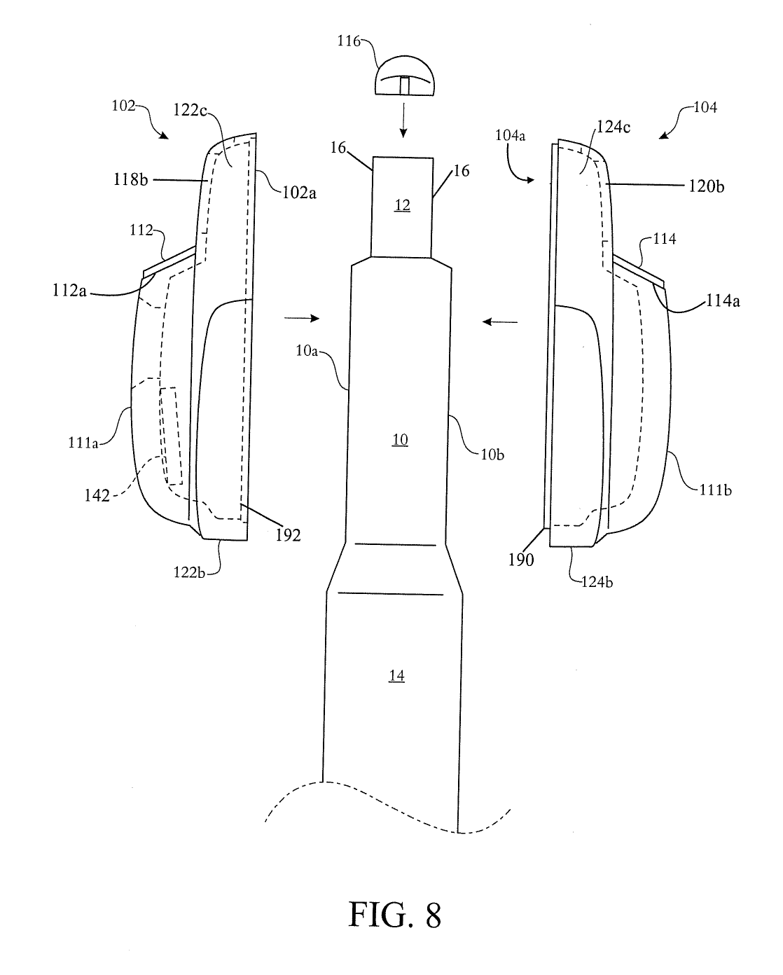

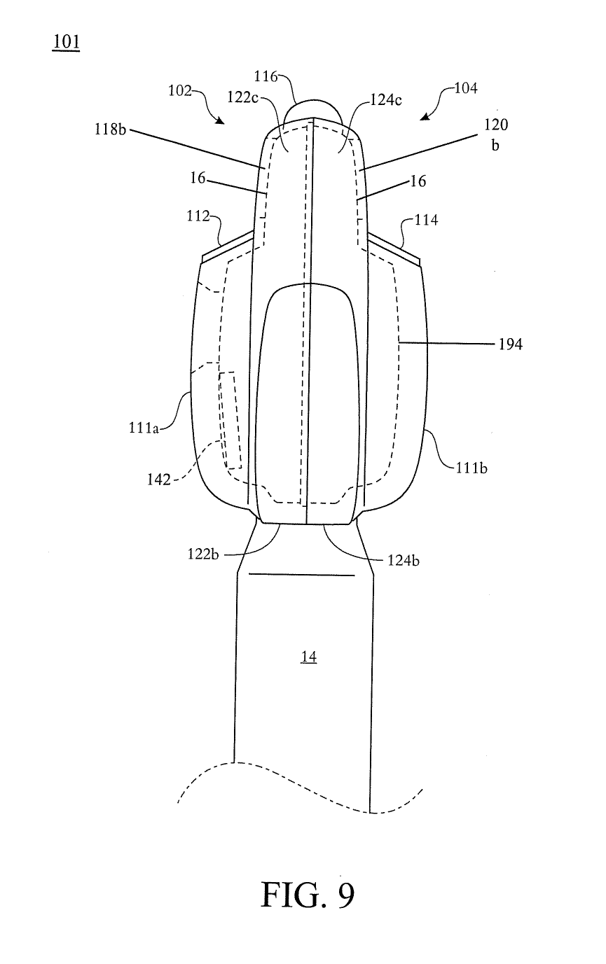

One or both of the front and rear portions 102, 104 may comprise a solar panel 112, 114, respectively, as discussed further below. The solar panels 112, 114 are supported by angled surfaces extending from the front and rear surfaces 111a, 111b, toward the openings 106, 108, which is better shown in FIGS. 8 and 9.

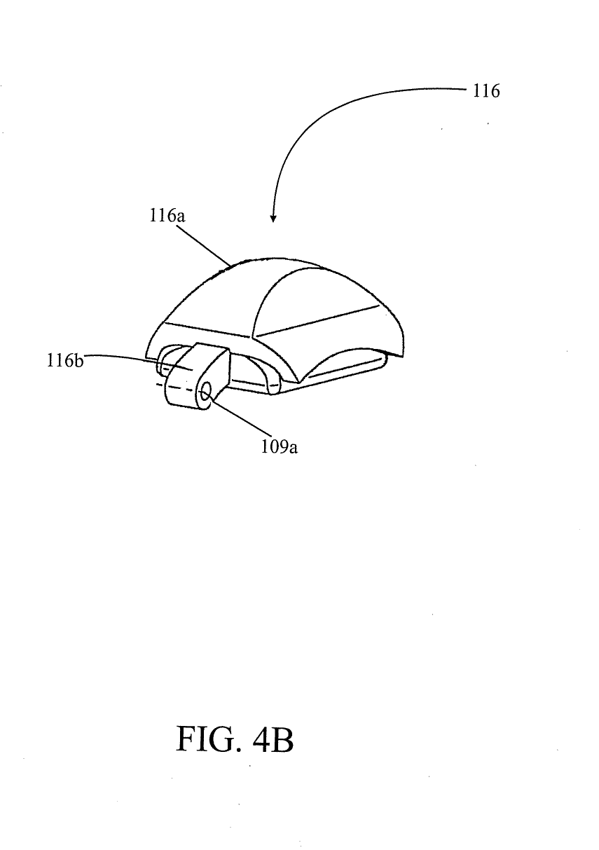

An indicator may be provided to indicate to a meter maid, for example, that the meter is paid for, as shown in FIG. 2. In this example, a light 116 is supported by the front and rear housings 102, 104 in a slot 115, as shown in FIGS. 3 and 5. FIG. 4A is a schematic representation of an example of a light assembly 116, which also has push button capability. FIG. 4B is a perspective view of an example of the light button 116 of FIG. 4A. The light button 116 includes a body portion 116a and extensions or wings 116b. Holes 109a are defined in the extensions 116b, to facilitate attachment of the light assembly 116 to the parking meter shell 101. The holes 109a correspond in position with the upper holes 109 in the front and rear portions 102, 104, shown in FIGS. 3 and 5, so that the same screws or bolts 107 that attach the front and rear portions 102, 104 to each other, go through the holes 109a in the extensions 116b, to secure the light button 116 in place in the slot 115.

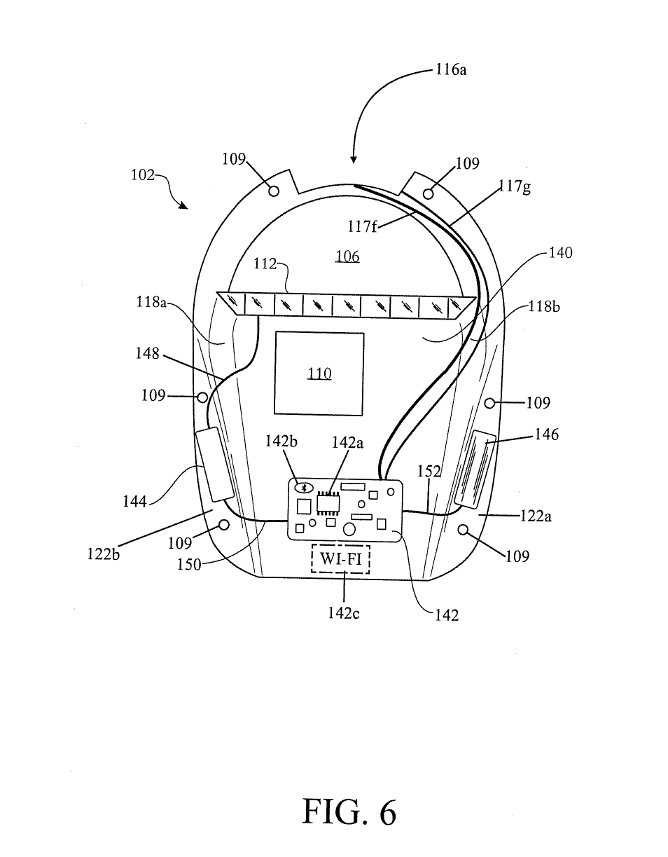

The body 116a may comprise a light emitting diode (“LED”) 117a. The body 116a may comprise flexible plastic body, for example, that is depressible. The plastic housing 116a may provide push button functionality through one or more springs 119 or other resilient members, for example. Depression of the plastic housing 116a such as by pressing the plastic housing down, brings an electrical contact 117c into contact with an electrical contact 117d. This completes a circuit comprising the contacts 117c, 117d and wires 117e, 117f, with a processing device 142 (as shown in FIG. 6), providing a signal to the processing device 142 to wake up from a rest state to start the payment process, and other functions, as discussed below.

A wire or copper lead 117g is also shown electrically connected to the LED 117a. The wire/copper lead 117g is electrically connected or electrically coupled to the processing device 142 to control operation of the LED 117a, as discussed further below. A second wire/copper lead, not shown in this view for ease of illustrations, would also be provided to complete the circuit. In one example, when the plastic housing 116a is depressed, the state of the light is changed. If the light was in an Off state, depression causes the state of the light to change to an On state, and if the light was in an On state, depression causes the state of the light to change to and Off state.

Alternatively, the indicator may be a sound device, such as a beeper, for example may be provided to emit different sounds or patterns of sound based on whether the meter is paid for or not. The functions of waking up the processing device and indicating that the parking space is paid for or not need not be in the same device. A button separate from the light 116 or sound device may be provided in a different location on the front or rear housing 102, 104, to turn on the processing device 142, for example.

Returning to FIGS. 3 and 5, the front portion 102 has right and left sidewalls 118a, 118b, which curve away from the front surface 111a, toward the rear portion 104. The rear portion 104 similarly has right and left sidewalls 120a, 120b, which curve away from the front surface 111b, toward the front housing 102. Extensions or wings 122a, 122b extend outward from each sidewall 118a, 118b of the front portion 102, respectively. Similarly, extensions or wings 124a, 124b extend outward from a terminating edge of each sidewall 120a, 120b of the rear portion 104, respectively. The wings 122a, 122b, 124a, 124b, have a thick, lower section at the sides of the front and rear portions 102, 104, and thinner upper sections 122c, 122d, 124c, 124d that curve toward each other, in the upper part of the portions 102, 104. The thicker sections are thick enough to accommodate, electrical components such as a battery, for example, as discussed further below. The upper, thinner sections 122c, 122d, 124c, 124d define, in part, the opening 106 108 that receive the transparent window 16 when the front and rear portions 102, 104 are attached to the parking meter 10, as shown in FIG. 2, for example.

The wings 120a, 120b, 124a, 124b each define the holes 109 for receiving screws or bolts 128, to connect the front and rear portions 102, 104 to each other, around the upper housing 12 of the parking meter 10, as shown in FIG. 2. Instead of screws, the front and rear portions 102, 104 may be connected by clips or clamps, for example. Alternatively, the front and rear portion 102, 104 may be configured to be snap fit and/or glued together, for example. Multiple attachment mechanisms may be provided.

FIG. 6 is a rear view of the front housing 102. The sidewalls 118a, 118b define a cavity 140. In this example, a processing device 142, such as a microcontroller, is supported by the rear surface of the front housing 102, within the cavity 140. A recess may be provided in the surface of the cavity to support the microcontroller 142. The processing device 142 may be a Bluetooth enabled RFDuino microcontroller available from RFDuino, Hermosa Beach, Calif., for example. A processor 142a and a Bluetooth chip 142b are indicated schematically on the microcontroller 142. An optional WiFi chip/chip set 142c is also shown on the microcontroller 142. The Bluetooth chip 142b and/or the WiFi chip/chipset 142c may also be separate from the microcontroller 142, and may be separately supported by the front or rear portion 102, 104, or other support, for example.

A battery 144 is provided in a recess (not shown) in the wing 122b. The battery 144 may protrude partially from the recess. A recess 146 is provided in the opposite wing 122a to receive a portion of another battery 176 in a recess (not shown) in the rear portion 104, as shown in FIG. 6 and discussed below. The battery 144 may be clicked into the recess between electrical contacts (not shown), for example. A wire or copper lead 148 is shown connecting the solar panel 112 to the battery 144, to recharge the battery, as needed. A wire/copper lead 150 is shown connecting the battery 144 to the microcontroller 142, to provide power to the microcontroller. Another wire/copper lead 152 is shown extending from the recess 146 to the microcontroller 142 to connect the battery 176 that protrudes from the recess in the rear portion 104 and will be received in the recess 146 after assembly, to the microcontroller 142. While single wires/copper leads are shown for ease of illustration, it is understood that parts of wires/copper leads are required between the components to form complete circuits.

One wire/copper lead designated as 117e, 117f represents the two wires/copper leads 117e and 117f shown in FIG. 4. Another wire 117g is also shown extending from the location of the light assembly 116 to the microcontroller 142, as in FIG. 4. As above, while one wire/copper lead is shown for ease of illustration, another wire/copper lead is required to complete the circuit.

The holes 104, which extend through the front housing, are also shown in FIG. 6.

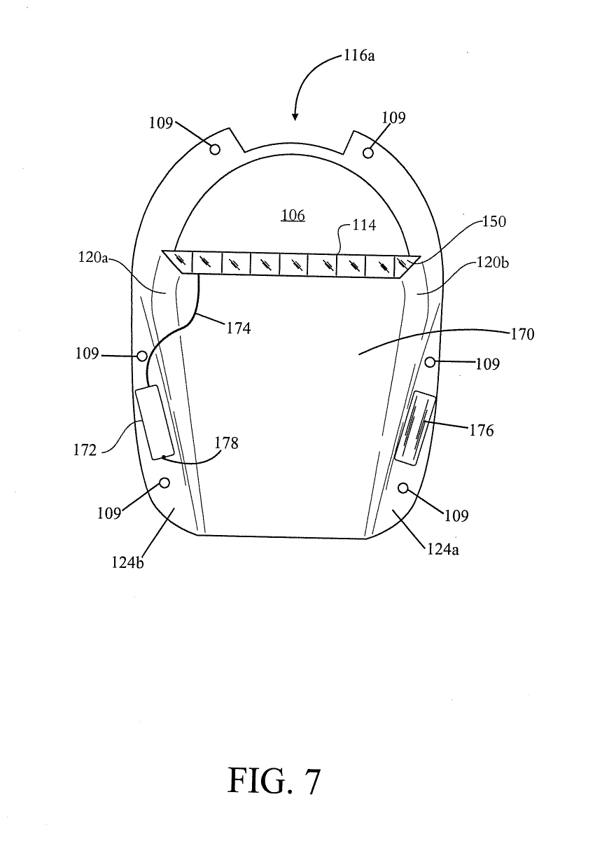

FIG. 7 is a rear view of the rear housing 104. The sidewalls 120a, 120b define a cavity 170 to receive a portion of the rear part of the parking meter 10 when the parking meter shell 101 is connected to the meter 10, as above.

The battery 172 is shown in a recess (not shown) in the wing 124b, as discussed above. A wire/copper lead 174 is shown connecting the solar panel 114 to the battery 172 to recharge the battery, if necessary. The battery 170 may be clicked into the recess, between electrical contacts (not shown). A recess 176 is provided in the wing 124a, to receive a portion of the battery 144 clicked into the recess of the front housing 102 and extending out of the recess, as discussed above.

A harness or seated ports (not shown) may be used to electrically connect the battery 170 in the rear housing 104 to the wire/copper lead 152, as indicated schematically by a contact or connector 178.

The front and rear portions 102, 104 of the meter shell 100 may comprise a hard plastic, such as a polycarbonate with or without fiber reinforcement, or other fiber reinforced plastic, for example. Alternatively, the front and rear portions 102, 104 may comprise synthetic fibers, such as para-aramid synthetic fibers. Kevlar® may be used for example. Plastic or synthetic fiber front and rear portions 102, 104 may be molded, for example. The recesses, such as the recesses 146, 176 may be defined by the mold. Reinforcing ribs (not shown) may also be defined on the inside surfaces of the front and rear portions 102, 104 for further support. Other appropriate materials may be used.

FIG. 8 is an exploded side view of the retrofitted parking meter 100 of FIG. 2, in accordance with an embodiment of the invention. The front portion 102 and the rear portion 104 face each other, with a conventional parking meter 10 in between. The front face 10a of the conventional parking meter 10a faces a rear side 102a of the front portion 102 and a rear face 10b of the conventional parking meter 10 faces a rear side 104a of the rear portion 104. The solar panel 112 is shown supported by an angled surface 112a of the front portion 102 and the solar panel 114 is shown supported by and angled surface 114a of the rear portion 104.

To assemble the retrofitted parking meter 100 in one example, the microcontroller 142 and the battery 144 are placed or snapped into the respective recesses in the rear of the front housing, if they are not already positioned. Similarly, the battery 172 is placed or snapped into position in the recess of the rear of the rear housing 104. Screws or bolts 107 may be placed through the upper holes 109 of the front or rear portions 102, 104 and through the holes 109a in the light assembly 116, which is positioned in the slot 115. The front portion 102 is placed adjacent to a front portion of the parking meter 10 to receive the front portion within the recess 140. Similarly, the rear portion 104 is placed adjacent to a rear portion of the parking meter 10 to receive the rear portion within the recess 150. The holes 109 of the front and rear portions 102, 104 and screws are screwed into the aligned screw holes of the front and rear portions 102, 104, connecting the front and rear portions 102, 104 to each other, around the parking meter 10. When assembled, as in FIG. 2 and FIG. 9, portions of the rear surfaces of the front and rear portions 102, 104 bear against the parking meter 10. An extending ridge 190 in the rear portion 104 may be received in an internal recess 192 in the front portion, or vice-a-versa, to assist in aligning the front and rear housing, for example, as shown in FIG. 8. The surfaces of the front and rear portions 102, 104 may conform, at least partially, to the front, and rear surfaces 10a, 10b, and side surfaces of the parking meter 10. In FIG. 9, the parking meter 10 is shown in dashed lines 194 in the assembled retrofitted parking meter 101.

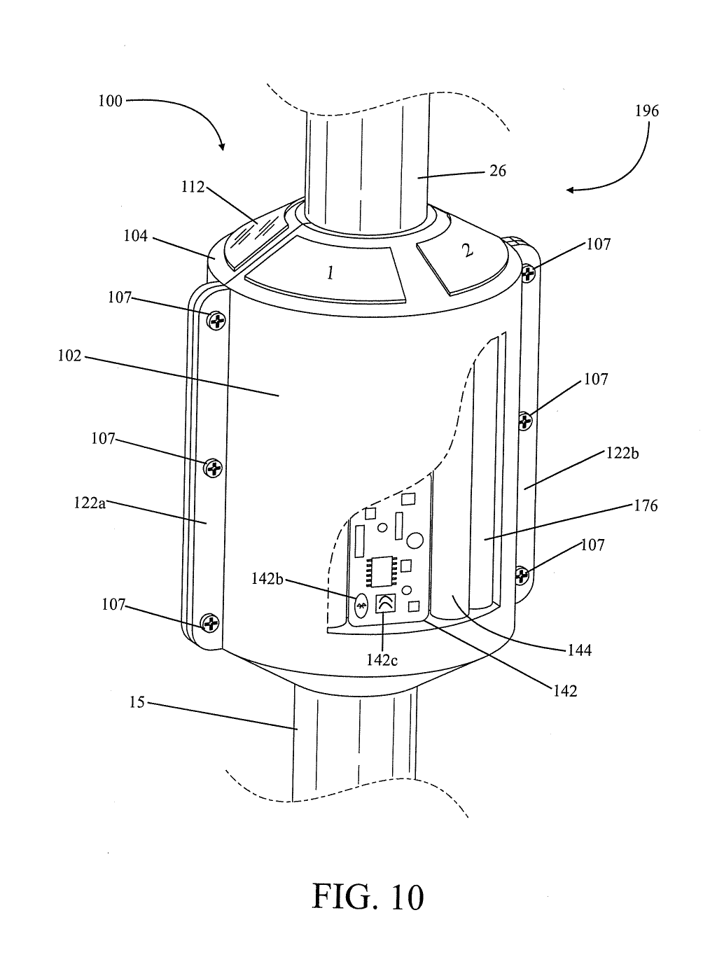

FIG. 10 is another example of a retrofitted parking meter 100. In this example, the parking meter shell 196 has an interior surface configured, at least in part, to bear against the pole 15, below the head portion 11. The front and rear portions are thereby clamped to the pole. 15. In FIG. 10, elements common to the parking meter shell 101 of FIGS. 3-9 are commonly numbered.

In this example, the outer surface and at least a portion of the inner surface of the front and rear housing 102, 104 are cylindrical. The Bluetooth enabled microcontroller 142 is supported by the front housing 102, along with batteries 144, 146. Additional batteries may be supported by the front and/or rear portions 102, 104. One or more solar panels 112 are supported by the rear housing 104 in this example.

This example of parking meter shell 196 is configured for use on a pole 26 that between two parking spots. Respective conventional parking meter heads may be supported by the same pole, as is known in the art.

When a user in the parking spot to the left or right of the pole 15, the user clicks on the respective button 1 or 2 corresponding to the parked in spot to wake up the microcontroller 142 to start the payment process for that spot.

The buttons 1, 2 may comprise the light assembly 116 as in FIG. 4 (suitably modified to connect to front housing 102 or the rear housing 104, or may be a button without a light. In that case, another indicator, such as a separate light or sound device, for example, may be provided to indicate that the parking spot corresponding to the parking meter has been paid for. If used to retrofit a single head parking meter 10, then only one button and one indicator, combined with the button or separate from the button, are provided.

### Parking Management and Payment System

FIG. 11 is a schematic representation of a system 200 in which retrofitted parking meter 100, may be used, in accordance with an embodiment of the invention. The system 200 comprises a parking management and payment system (“processing system”) 202. The processing center 202 may be part of one or more servers, for example. The one or more servers may be cloud based servers, for example.

A user's smart device 206, such as a smart phone, tablet, smart watch, or other portable smart devices, are shown. The user's smart device 206 communicates with the processing system 202 via a network 208. The network 208 may comprise one or more networks, such as a cellular network, a WiFi network, and/or the Internet, for example.

As shown in 206a, the user's smart device 206 comprises a processing device 210, memory 212, a software parking App 214 stored in the memory, and a display 215. A user pays for time to park or extends the time to park at the retrofitted parking meter 100 via the user's smart device 206, under the control of the App 214.

The processing center 202 comprises one or more processing devices 214 and storage, such as one or more databases 216, for example. The database 216 stores profile information of users and/or their smart devices provided during registration with the system 200 and at later times, for example. The profiles may include credit/debit card information and/or account balances for respective users. The processing center 202 performs the payment and stores information including user profiles, log-in information, and credit/debit card information. Payment may be performed by deducting the cost of parking in the spot for a selected amount of time, from money in a user's account, or through the credit/debit card, for example. The credit/debit card information may also be used to replenish the account balance. In addition, the processing center 202 may track time and send notification to user's concerning how much time is left at their parking spot and whether time has expired, as discussed below.

The database 216 may also store rate information for respective meters provided by a municipality. The rate information may be provided and updated by the Department of Motor Vehicles (“DMV”) 220 via the network 208, for example. Rate information, which includes cost per incremental parking time period, may also vary based on location, time of day, and day of the week. The rate information may also include maximum parking times, which may also vary based on these and/or other factors.

The rate information may be sent to the user's smart device 206, via the network 208, for storage in the memory 212, for example. The rate information may be used by the App 214 to calculate the cost of parking at a respective parking meter, and/or may be used by the processing center 202 for the same purpose. If the rate information changes, the updated information may be provided to the user's device 206, via the network 208.

In this example, the smart device 206 communicates with the microcontroller 152 in the parking meter shell 101 of the retrofitted parking meter shell 100 via Bluetooth and the microcontroller 152 does not communicate directly with the processing center 202. If the microcontroller has WiFi capability and the municipality has adequate WiFi coverage, then the retrofitted parking meter 101 may communicate directly with the processing center 202 via the network 208.

In accordance with another embodiment of the invention, the processing center 202 also enables the payment of tickets and fines to the Department of Motor Vehicles (DMV″) 220, as discussed further below. The DMV 220 in the municipality where the retrofitted parking meter 200 is located may communicate with the processing center 202 via the network 208.

### Operation

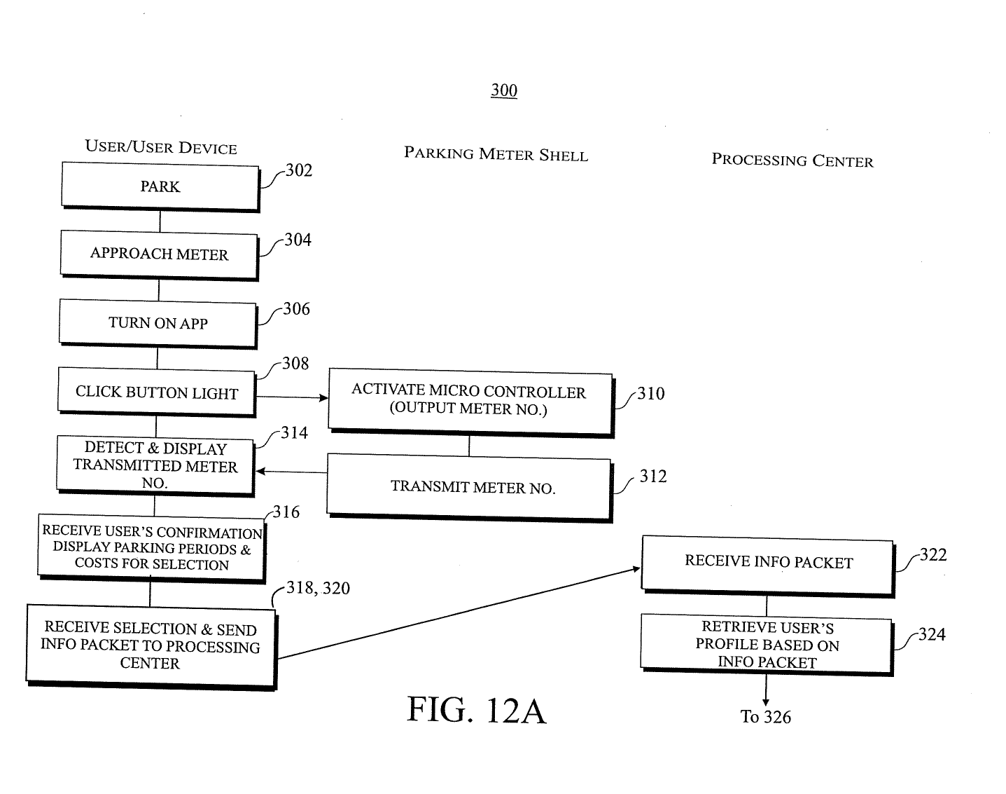

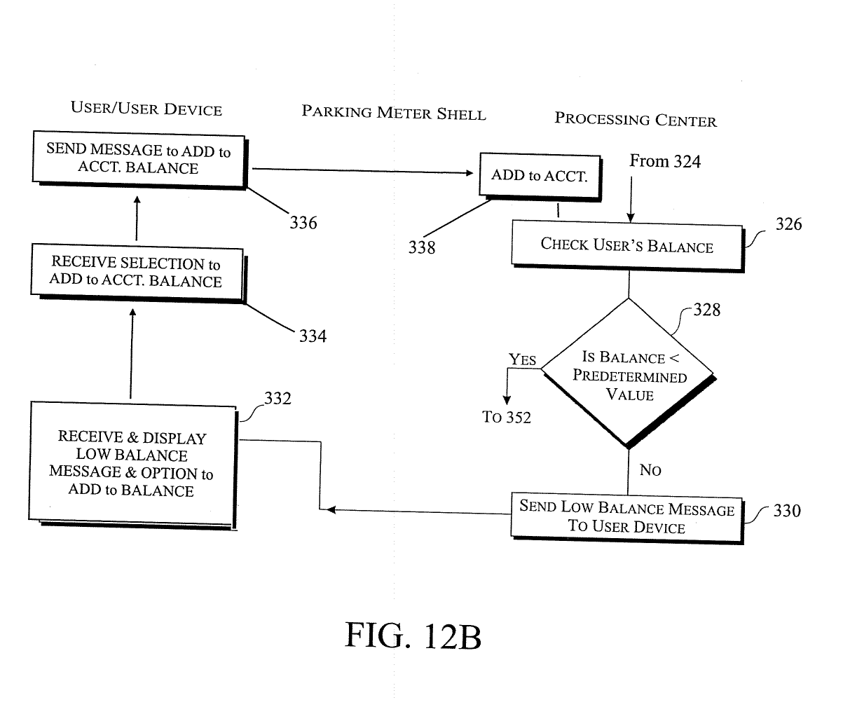

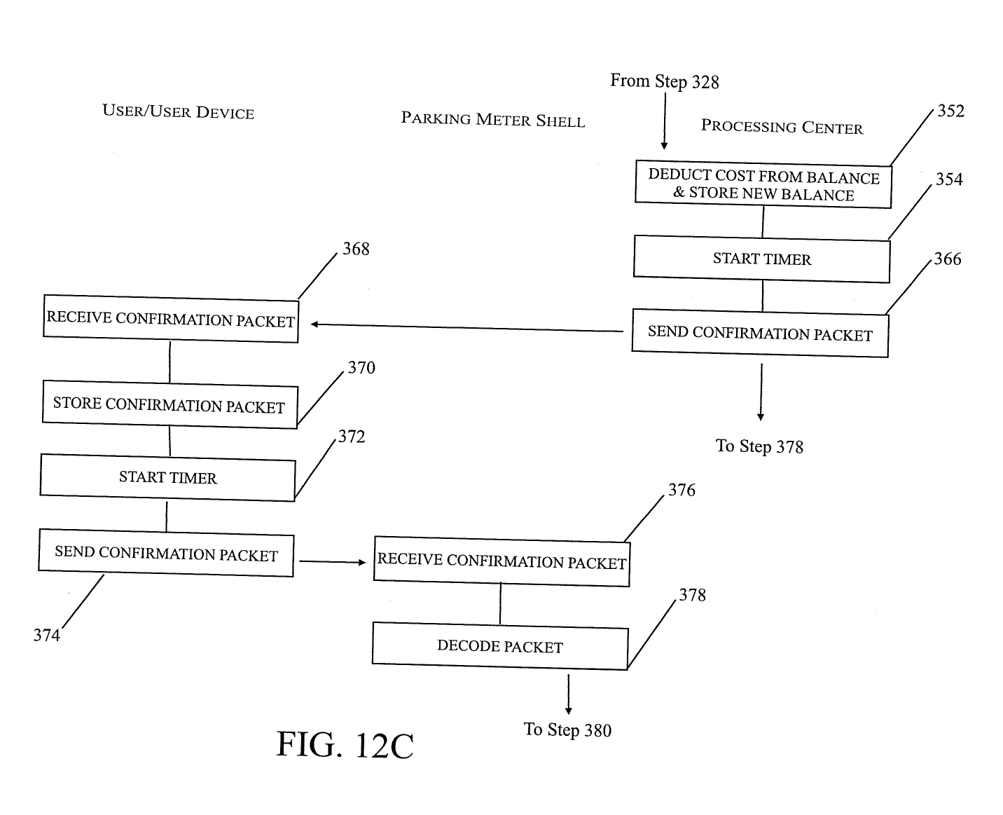

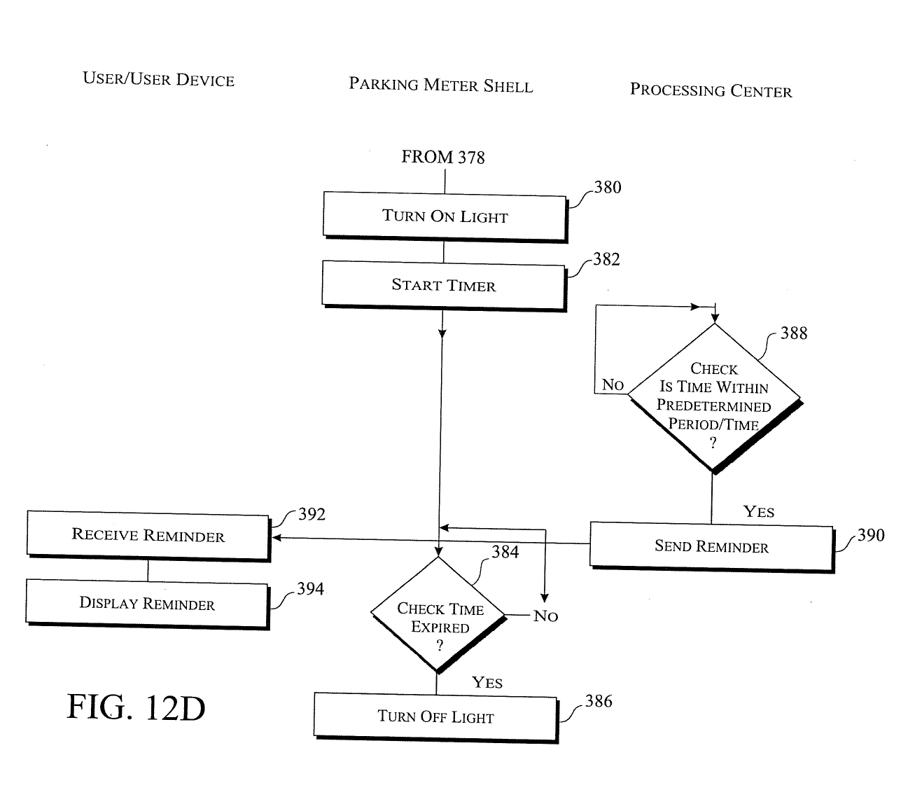

FIGS. 12A-12D show a flowchart 300 of an example of a method of paying for parking space, in accordance with an embodiment of the invention. In this example, the parking meter shell 101 is only configured to communicate via Bluetooth.

After a user parks in a parking space, in Step 302, the user approaches the retrofitted parking meter 100 with their smart device 206 and opens the parking App 214 on their device, in Steps 304 and 306. In this example, the user clicks on the light 116, or another button on the parking meter shell 101, to wake-up the microcontroller 152, in Step 308. The microcontroller 152 receives a signal from the clicked light 116, activates, and outputs the number of the meter (“meter number”), in Step 310. The meter number is transmitted by Bluetooth within a range of 25-30 feet, for example, in Step 312.

The user's smart device 206 detects and displays the meter number, for example, in Step 314. The parking App 214 may display the received meter number for the user to confirm that the number matches the number of the meter at parking space, for example. Alternatively, the user may be prompted to enter the meter number, to confirm that they match.

When the user confirms that the received meter number corresponds to the meter number indicated on the parking meter, the App 214 displays parking time periods and costs for parking at that meter on that day, at that time of the day, up to the maximum time period allowed at that meter, and an option to select a particular parking time period, on the display 215 of the user's device, in Step 316. The App 214 knows the cost based on the stored rate information periodically provided by the processing center 222 for respective meters in a municipality via the network 208, for example, as discussed above.

The user selects the desired time period on the display 215, which is received by the App 214, in Step 318.

The user's smart device 206, under the control of the App 214, sends an Info packet containing the meter number, the selected cost to park in the spot for the selected period of time, and an identification of the smart device 206 and/or the user 204, for example, to the processing center 202, via the network 208, in Step 320.

The processing center 202 receives the Info packet, parses the packet to identify the user or user's smart device, and retrieves the profile of the user or user's smart device identified in the Info packet, including the user's account balance, in Steps 322 and 324.

The processing center 202 checks the user's account balance and determines whether the balance is greater than the cost of the selected time period, in Steps 326 and 328.

If the user's account balance is not greater than the selected cost (No in Step 328), the processing center 202 sends a low balance message to the user's smart device 206, indicating that the user must add money to the balance to proceed, in Step 330. The App 214 receives the message and displays the appropriate notification on the display 215 of the user's device 206, in Step 332. The user 204 may add money to their account by transferring money from a bank account or charging the money to a credit/debit card in their profile, via the user's smart device 206, under the control of the App 214. If the user selects to add money to the account balance, which is received by the App 214 in Step 334, the App sends a message to the processing center to add the money, in Step 336. The processing center 202 receives the message and adds the money to the user's account, in Step 338. The user may also mail money to their account, but then they could not park until the money was received.

The processing center 202 may then check the user's balance again in Steps 326 and 328.

When it is determined that the account balance is greater than the cost (Yes in Step 328), the processing center 202 deducts the cost from the user's account to proceed, in Step 352. The processing center 202 also starts a timer to count down the paid for time, and sends a confirmation packet including confirmation of payment, the user's current balance, and the time the paid for parking expires, for example, to the user's device, via the network 208, in Steps 354 and 356. The confirmation packet also includes an encrypted message that confirms for the user and the parking meter shell 101 that the transaction has taken place. It is noted that other messages between the processing center 202, the microcontroller 142, and the smart device 206 may be encrypted for security in any suitable manner known in the art.

When the user's smart device 206 receives the confirmation packet, in Step 368, the App 214 stores the packet in memory 212 on the device in Step 370. This acts as a record of receipt for the user. The App 372 starts a timer to count down the paid for time in Step 372, and sends the confirmation packet, or a portion thereof, to the parking meter shell 101, via Bluetooth, in Step 374.

When the microcontroller 142 receives the confirmation packet/receipt via Bluetooth, in Step 376, the microcontroller decrypts the encrypted message, in Step 378. If the decrypted message is authenticated (understandable and from a verified source (such as from the processing center 202 and/or the correct smart device 206)) the microcontroller 152 turns on the light 116, in Step 380, to indicate that the parking spot is paid for. The microcontroller 142 also starts a timer to count down the paid for time, in Step 382. The microcontroller 142 may go to sleep after the light is turned on, even though it continues to countdown the paid for time.

If the timer on the microcontroller indicates that the time has expired, in Step 384, the light 116 is turned off, in Step 386. If the car is still in the parking space, a meter maid can readily determine that the car has not paid for the current time, and issue a ticket.

Prior to that, however, when the timer of the processing center 202 counts down to a predetermined amount of time prior to expiration of the paid for time, such as 5 or 10 minutes prior to expiration, in Step 388, the processing center 202 sends a notification to the user's device, in Step 390.

When received by the user's device, in Step 392, the App 214 displays the notification or other such message that indicates that the time will expire in the predetermined amount of time, in Step 394.

The timer on the App 214 also counts down the paid for time and provides notifications a predetermined amount of time prior to the expiration of the paid for time, in a similar manner as the processing center 202. The predetermined amount of time may be the same as the predetermined amount of time used by the processing center 202, or may be different. The App 214 provides notification to the user based on its own timer and based on messages received from the processing center 202, whichever is received first. If the user's device 204 is in an area with poor cell service, such as in restaurants or stores, for example, messages may not be received from the processing center 202. In that case, the user would rely on the notification from the smart device 206.

In the present example, where the parking meter shell 101 can only communicate via Bluetooth, if the user wants to extend the time at the meter, the user must be within the Bluetooth range of the chip, which is from about 25-30 feet. The user approaches the respective parking meter 100 and repeats Steps 304-394 to add time to the meter to extend the allowed time for parking. It is noted that if the light 116 is already On because time has not run out, when the light is clicked again by a user, the microcontroller 142 will wake up again in Step 310 and cause the light to flash to show that there is pending activity, until the process of paying for additional time is completed. As the payment of additional time proceeds, the processing center 202, the smart device 206, and the microcontroller 142 appropriately reset their timers to add the newly added time to the remaining paid for time.

If the user leaves the parking space prior to expiration of time, the user may click on the light 116 or other button to turn off the light. If there is remaining paid for time, the time may be credited back to the user's account. In one example, after the light is clicked off, the microcontroller 142 sends a message to the smart device 206 indicating the remaining time based on its timer, via Bluetooth. The App 214 then sends the message to the processing center 202, via the network 228, which credits the value of the remaining time to the user's account.

If the parking meter shell has WiFi capability and the municipality has good WiFi coverage, the microcontroller 142 and the processing center 206 may communicate directly with each other and with the user's device 296, allowing for remote payment to extend paid for time at the meter. WiFi communication to and from the microcontroller 142 is indicated by the dashed lines in FIG. 11. Other combinations of interactions may be performed. For example, the retrofitted parking meter may send notifications prior to the paid for time expiring, instead of or in addition to the smart device 206 and the processing center 202. In addition, a user may remotely pay for additional time via the processing center 202, which then instructs the microcontroller 142 to reset its timer. Alternatively, the processing center 202 can control operation of the parking meter shell 101 by instructing the microcontroller 142 to turn the light on and off at appropriate times, based on selections and authorizations to pay for time sent by the smart device 206.

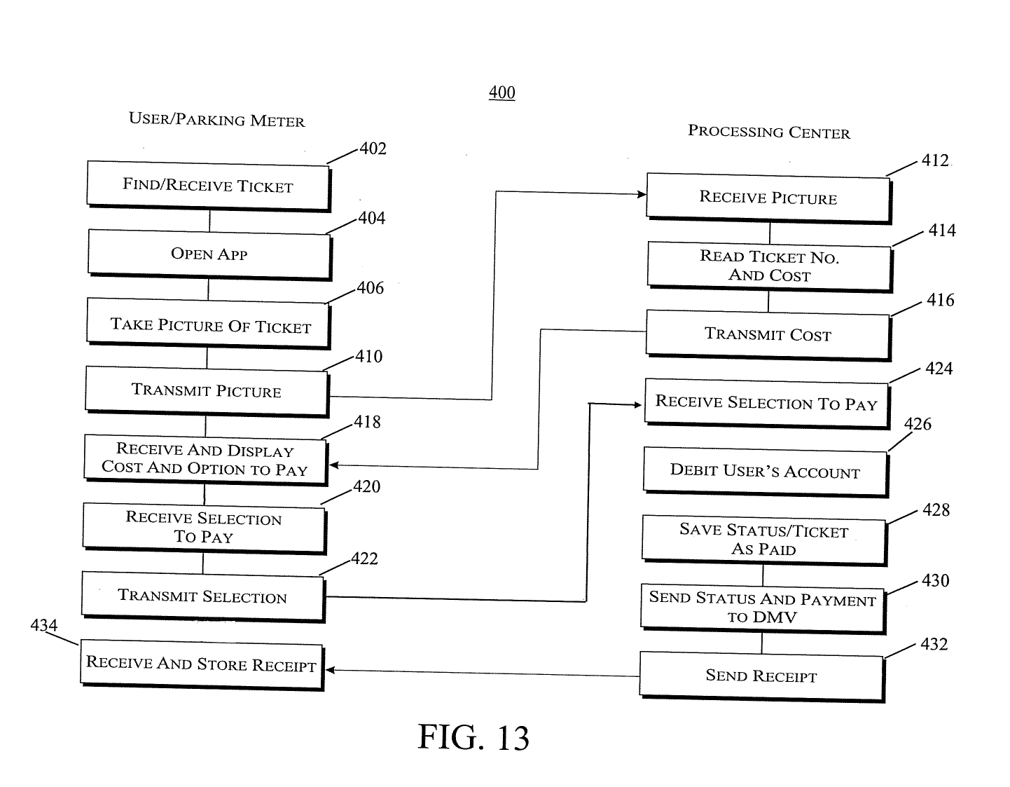

In accordance with another embodiment of the invention, tickets may be paid through the system 200. FIG. 13 is a flowchart 400 of an example of a method for paying parking tickets, in accordance with an embodiment of the invention. A ticket may be found on a user's car windshield or received in the mail, in Step 402. The user opens the App 214, in Step 404, and takes a picture of the ticket by a camera enabled smart device, such as a smart phone or tablet, for example, in Step 406. The App 214 causes the picture of the ticket to be transmitted to the processing center, in Step 410. Alternatively, the user may scan the ticket and send the scanned ticket, in the form of a PDF document, for example, to the processing center via email, for example. The ticket could also be sent by facsimile to the processing center 202.

The processing center 202 receives the picture in Step 412. The processing center 202 then reads the ticket to determine the ticket number and the cost of the fine, which is also typically on the ticket, in a manner known in the art, in Step 414. Optical character recognition (“OCR”) may be used, for example. In Step 414 the OCR performed by the App 214 may use a preconfigured template or an on-the-fly character pattern recognition matching routine, for example. Alternatively, the picture of the ticket or a scanned image of the ticket may be read by the smart device 206, under the control of the App 214. The App 214 would then send the ticket number and cost of the fine to the processing center 202.

The processing center 202 transmits the cost of the fine to the smart device 206, via the network 208, in Step 416.

The App 214 receives the message, displays the cost of the fine, and presents an option to pay on the display 215, in Step 418. The smart device 206 receives the selection to pay, in Step 420, and transmits the selection to the processing center 202, in Step 422.

The processing center 202 receives the selection in Step 424 and if the user selected to pay, the processing center 202 debits the user's account for the cost of the fine, in Step 426. The fine may also be paid with the user's credit card number, which was stored during the registration process.

When payment is made, the processing center 202 saves the status of the ticket as being paid, in Step 428, and sends the status and payment to the DMV 220, in Step 430. Payment may be made to the DMV in batches of payments for users of the App according to a schedule desired by the municipality, for example, or on a per payment basis.

The processing center 202 sends a receipt to the user's smart device, for storage by the App, in Step 432. The user's device 206 receives and stores the receipt, under the control of the App 214, in Step 434.

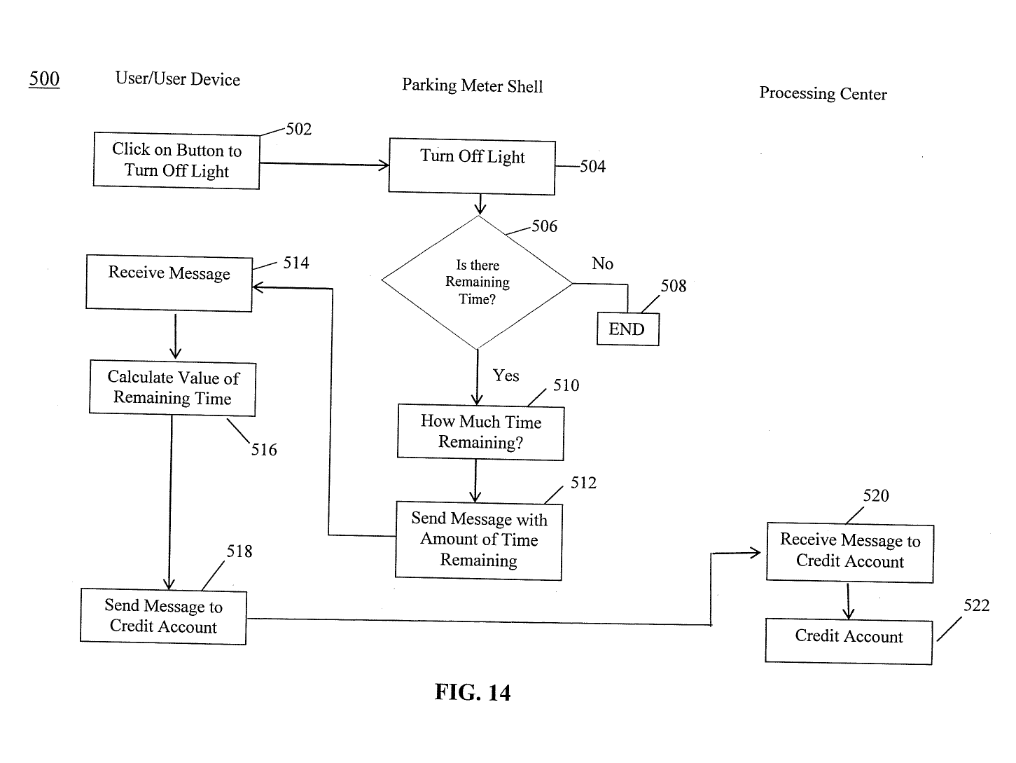

In accordance with another embodiment of the invention, if the user is ready to leave the parking space prior to expiration of time, the user may be credited for the value of the remaining time. FIG. 14 is a flowchart 500 of an example of this embodiment of the invention. In Step 502, the user clicks on the light 116 or other button to turn off the light, prior to leaving the spot. The microcontroller 142 receives a signal that the light button 116 has been depressed from the light button via the wires 117f,117g (see FIGS. 4 and 6) and changes the state of the light from On to Off, in Step 504. The microcontroller 142 checks whether there is remaining time on the timer, in Step 506. If No, the process ends, in Step 508.

If Yes, the microcontroller 142 determines how much time is remaining, in Step 510, and sends a message to the user's smart device, which is still within Bluetooth range of the parking meter, that there is “X” time remaining, in Step 512

The user's device receives the message in Step 514, calculates that value of the remaining time based on the rate information, for example, in Step 516, and sends a message including the value of the time, in Step 518. The processing center 202 receives the message in Step 520 and then credits the user's account for the value of that amount of time, in Step 522.

Although the present invention has been described in considerable detail, those skilled in the art will appreciate that numerous changes and modifications may be made to the embodiments and preferred embodiments of the invention and that such changes and modifications may be made without departing from the spirit of the invention. It is therefore intended that the appended claims cover all equivalent variations as fall within the scope of the invention.

For example, while the front and rear housing portions are said to be connected to each other, the connection may be through other housing portions. In addition, other attachment mechanisms for retrofitting a parking meter 10 to include wireless communication connectional/capability, such as belts or harnesses supporting wireless communication components, may be used. In addition, instead of attaching portions of the parking meter shell 101 to each other to attach the shell to the parking meter, a support supporting a wireless enabled processing device may be directly connected to an external surface of the parking meter such as by bolts or screws or other attachment mechanism. These and other variations that may be contemplated by those of ordinary skill in the art, are within the scope of the invention.

We claim:

1. A parking meter accessory for retrofitting a parking meter for wireless communication, wherein the parking meter comprises a parking meter head and a pole supporting parking meter head, the parking meter accessory comprising:
at least one support for attachment to an external surface of at least a portion of the parking meter; and
at least one processing device configured for wireless communication;
wherein the at least one support is configured to support the at least one processing device.

2. The parking meter accessory of claim 2, wherein:
the at least one support is configured to connect to at least a portion of the parking meter head.

3. The parking meter accessory of claim 2, wherein the at least one support comprises:
a front housing portion; and
a rear housing portion;
wherein the front housing portion and the rear housing portion are configured to be connected to the parking meter.

4. The parking meter accessory of claim 3, wherein:
the parking meter head comprises a transparent window in front of a meter mechanism; and
the front housing portion and/or the rear housing portion define an opening in a position corresponding to the transparent window, when the front portion and the rear portion are connected to each other around at least a portion of the parking meter.

5. The parking meter accessory of claim 3, wherein:
the parking meter head comprises a payment section to receive payment by coin and/or credit card; and
the front housing portion further defines an opening in the front portion in a position corresponding to the payment section on the parking meter when the parking meter shell is connected to the parking meter.

6. The parking meter accessory of claim 2, wherein the parking meter shell further comprises an indicator that payment was made.

7. The parking meter accessory of claim 2, wherein;
wherein the at least one processing unit is configured to control, at least in part, operation of the indicator between On and Off states.

8. The parking meter accessory of claim 2, wherein the indicator comprises a light.

9. The parking meter accessory of claim 8, wherein:
the light is configured to be manually activated; and
the at least one processing device is configured to wake-up from a rest state by manual activation of the light.

10. The parking meter accessory of claim 7, wherein the processing device is configured to turn on the light when the processing device receives confirmation that payment has been made.

11. The parking meter accessory of claim 8, wherein the processing device is configured to turn off the light when paid for time expires.

12. The parking meter accessory of claim 2, wherein at least one of the front housing and the rear housing are configured to support a battery to power the processing device, the parking meter shell further comprising:
a solar panel to charge the battery.

13. The parking meter accessory of claim 2, wherein the portion of the parking meter shell is configured to connect to the pole.

14. The parking meter accessory of claim 2, wherein the first housing portion and the second housing portion are configured to be attached to the parking meter by being connected to each other, around at least a portion of the parking meter, to be clamped against the portion of the parking meter.

15. The parking meter accessory of claim 16, wherein the at least one shell portion comprises:
a front housing portion; and
a rear housing portion;
wherein the front housing portion and the rear housing portion are configured to be connected to the pole.

16. The parking meter accessory of claim 1, wherein the at least one processing device is configured for Bluetooth and/or WiFi communication.

17. The parking meter accessory of claim 16, wherein conventional parking meter has a meter identification and the at least one processing device is configured to transmit the identification via Bluetooth.

18. A retrofitted, wireless parking meter comprising:
a non-wireless parking meter; and
a parking meter accessory comprising:
a support attached to an external surface of the parking meter; and
at least one processing device configured for wireless communication, supported by the support.

19. A processing system for the wireless payment of parking tickets, comprising:
storage storing payment information for a respective user; and
a processing device configured to:
receive an image of a parking ticket, from a user, via a network;
read the image to derive a ticket number and cost of the ticket; and
pay the cost of the ticket based on the stored payment information.

20. The processing system of claim 19, wherein the stored payment information comprises an account balance, credit card information, and/or debit card information.

21. The processing system of claim 20, wherein:
the stored payment information comprises a user's account balance; and
the processing device is configured to pay the cost of the ticket by deducting the cost from the user's account balance.

22. The processing system of claim 19, wherein the processing system is further configured to send a record of receipt of payment to the user's smart device, via the network, after payment of the cost of the ticket.

23. A method of paying a parking ticket, comprising:
receiving an image of a parking ticket, from a user, via a network;
reading the image to derive a ticket number and cost of the ticket; and
paying the cost of the ticket based on the stored payment information.

24. A processing system comprising:
storage; and
a processing device configured to:
wirelessly communicate with a smart device and/or a retrofitted parking meter, via a network, to process remote payment for parking in a parking space, initiated by the smart device.

25. The processing system of claim 24, wherein:
the processing device is configured to receive a meter identification, identifying information of the smart device, and a selected parking time from a smart device via the network, the smart device receiving the meter identification from the retrofitted parking meter via Bluetooth.

26. The processing system of claim 25, wherein the processing device is further configured to:
determine whether a user's account balance is greater than the cost of parking for the selected period of time, and if it is, deduct the cost from the account balance;
send a confirmation of payment to the smart device, via the network, the confirmation to be sent to the retrofitted parking meter to confirm for the retrofitted parking meter that payment was made;
start a timer to count down the paid for time; and
provide a notification to the smart device a predetermined amount of time prior to expiration of the paid for time period.

27. The processing system of claim 20, wherein the processing device is further configured to add value to the user's account if the smart device and/or the retrofitted parking meter send a message to the processing device that the user has left the parking space prior to expiration of the paid for time period.

28. A portable smart device comprising:
storage storing a software application; and
a processing device configured to communicate wirelessly with a processing center and a retrofitted parking meter retrofitted to enable wireless communication, to pay for time to park at a parking space, under the control of the software application.

29. The portable smart device of claim 28, wherein the processing device is further configured to count down the paid for time and display a notification to the user a predetermined amount of time prior to expiration of the paid for time, under the control of the software application.

30. The portable smart device of claim 28, wherein the processing device is configured to:
receive a meter identification from the retrofitted parking meter via Bluetooth; and
transmit the meter identification to a remote processing center via WiFi.

31. A method of retrofitting a conventional parking meter without wireless capability, comprising:
providing a support supporting a wireless enabled processing device: and
attaching the support to an exterior surface of the conventional parking meter.
